(19) United States
(12) Patent Application Publication
(10) Pub. No.: US 2022/0138843 A1
(43) Pub. Date: May 5, 2022

(54) METHODS AND APPARATUSES FOR CORE BANKING FUNCTIONALITY AND PHYSICAL DOCUMENT CONTROL EMPLOYING AN IVATR WITH A GENESIS PORTION AND ASSOCIATED STORAGE PORTIONS

(71) Applicant: FinLink, Inc., Healdsburg, CA (US)

(72) Inventor: Vladimir LOUNEGOV, Walnut Creek, CA (US)

(21) Appl. No.: 17/088,248

(22) Filed: Nov. 3, 2020

(51) Int. Cl. G06Q 40/02; G06Q 40/04; G06Q 20/10; H04L 9/06

(52) U.S. Cl. CPC G06Q 40/02; G06Q 40/04; H04L 2209/38; H04L 9/0643; G06Q 20/10

(57) ABSTRACT

Computer-based methods and apparatuses for using complex data structures such as blockchains and other IVATRs to perform core banking functions. Computer-based methods and apparatuses, employing a genesis portion and plurality of data storage portions, to perform such functions.

### FIELD OF THE INVENTION

The present invention relates in general to systems, apparatuses and methods using electronic independently verifiable records to perform core banking functions.

### BACKGROUND OF THE INVENTION

As discussed for example in U.S. Publication No. 2017/0048216 of Chow et al., U.S. Publication No. 2020/0068013 of Zakharov et al., International Publication No. WO 2017/0145004 A1 of Wright et al., and International Publication No. 2019/199288 A1 of Andrade, blockchain technology has been used for a variety of applications, including managing of legal documents and other records management functions and financial services functions.

However, there is a need for more convenient, efficient and secure ways of using blockchain or other independently verifiable records to perform banking functions such as physical document access control.

### SUMMARY OF THE INVENTION

This disclosure provides tools (in the form of apparatuses, methodologies and systems) allowing for convenient, efficient and secure use of an independently verifiable asset transaction record (IVATR) such as blockchain, having a initially created and directly addressable storage portion thereof, such as a genesis block or IVATR “core” or “header”, and a plurality of further storage portions or blocks linked thereto, to perform banking functions such as physical document access control.

### BRIEF DESCRIPTION OF THE DRAWINGS

Further features and advantages of the invention may be understood by reviewing the following detailed description of the preferred embodiments of the invention taken together with the attached drawings, in which:

FIG. 1 is a system architecture diagram showing a system on which various methods according to embodiments of the present invention may be performed, according to an exemplary embodiment.

FIG. 2 is a flow and decision chart for a deposit request employing the creation of genesis block and further additional associated blocks according to an exemplary embodiment of the present invention;

FIG. 3 is a flow and decision chart for a safe deposit storage request employing the creation of genesis block and further additional associated blocks according to an exemplary embodiment of the present invention;

FIG. 4 is a flow and decision chart for a safe deposit access request involving the performance of smart contract-related functions according to an exemplary embodiment of the present invention; and

FIG. 5 is an exemplary embodiment of a data structure diagram showing an IVATR with a genesis storage portion and additional linked storage portions, and artifacts in separate storage, which data structure may be used according to various systems and methods of the present invention.

### DETAILED DESCRIPTION OF THE DRAWINGS AND PREFERRED EMBODIMENTS

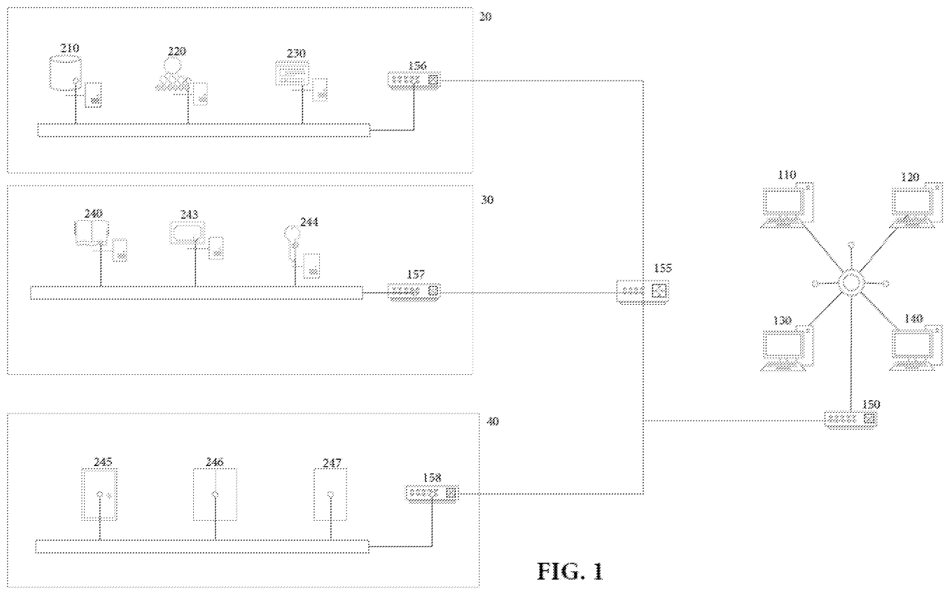

FIG. 1 is a system architecture diagram showing a system usable for the performance of various methods according to embodiments of the present invention.

This system architecture may include a core banking network or infrastructure 20, an access management network or infrastructure 30, and a blockchain network or infrastructure 40. These networks or infrastructures 20; 30; 40 may be connected by input/output devices internal to these networks 156; 157; 158 and input/output devices external to these networks 155; 150 to external user-accessible computing systems 110; 120; 130; 140. Processing devices, such as computer processors and servers, may be located in the vicinity of or incorporated into the various input/output devices or the internal components of these networks or infrastructures 20; 30; 40 or distributed elsewhere along the system architecture.

The core banking network or infrastructure 20 may be comprised of one or more access-controlled document databases 210, one or more access controlled record index databases 220, and access-controlled interfaces 230. These access-controlled items may be connected along a bus or other internal network to input/output device 156. Access to these access-controlled items 210; 220; 230, including to particular portions of the associated data and functionality, may be managed by access management network or infrastructure 30. The document database 210 may store documents, for example, in the form of a relational database, indexed by record index database 220.

Access management network or infrastructure 30 may be comprised of certificate store 243, a key store 244, and key/certificate index 240 for the association of such keys and/or certificates with appropriate users and/or access rights. The certificate store 243, key store 244 and key/certificate index 240 may be connected along an internal network to input/output device 157. This infrastructure may be used to control access to assets stored in the core banking infrastructure 20 or elsewhere for example by public-key encryption or other methodologies as may be known in the art.

Blockchain management network or infrastructure 40 may be comprised of one or more servers 245; 246; 247 which can operate to drive a consensus mechanism for confirmation for the relevant blockchain and/or other IVATR.

The foregoing networks or infrastructures may be accessed, depending on the grant of access rights, by users using user computing devices and/or terminals 110; 120;130; 140 connected over a network ultimately to input/out device 150 which in turn connects to the blockchain infrastructure 40 and input/output server 155.

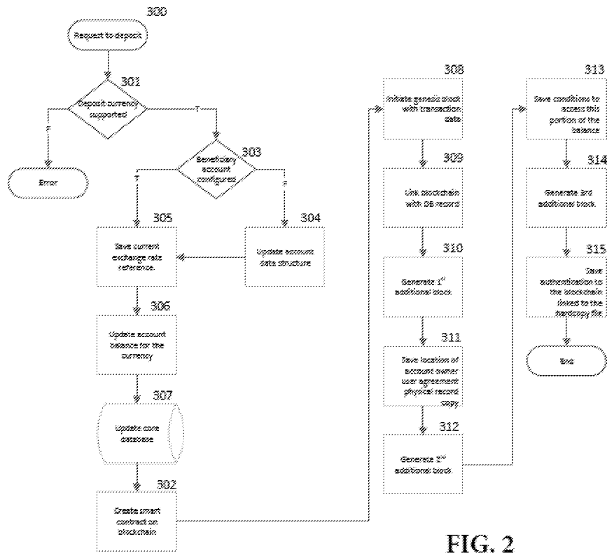

FIG. 2 is a flow and decision chart for a deposit request employing the creation of genesis block and further additional associated blocks according to an exemplary embodiment of the present invention.

In an aspect of the invention, a user may make a request to deposit (at step 300) a deposit currency to the system, such as core banking network or infrastructure 20. If it is determined at step 301 that the deposit currency that is the subject of the request is supported by the banking system, then, at step 303, a determination may be made as to whether beneficiary account has already been configured for the user. If the deposit currency is not supported, and error may instead be returned.

If the beneficiary account has not been configured, then the data structure of the user's account can be updated at step 304, for example in order to configure a beneficiary account, for example by placing the account in the beneficiary institution's format.

At step 305, a reference to a current exchange rate applicable to the currency that is the subject of the request may be saved. The user's account may be updated, at step 306, with respect to the balance of that currency. At step 306, the core database may also be updated. At step 302, a smart contract may be created. This smart contract may be stored on the blockchain, or on another IVATR. At step 308, a genesis block, or a IVATR header or IVATR core may be created associated with or containing data relating to the transaction. At step 309, a link or other association may be created between the blockchain or IVATR and a record in the core database relating to the deposit transaction. At step 310, a first additional block of the blockchain, or an additional storage portion of the IVATR, may be generated. At step 311, the location of a physical record copy of the account owner user agreement may be saved, for example in additional blockchain block or IVATR storage portion generated in step 310. At step 312, a second additional block of the blockchain, or an additional storage portion of the IVATR, may be generated. At step 313, conditions necessary to access the balance associated with the deposit may be saved, for example in the second additional block or additional storage portion generated at step 312. At step 314, a third additional block of the blockchain, or an additional storage portion of the IVATR, may be generated. At step 315, a record relating to the authentication of the hardcopy file, for example by scanning of the hardcopy file at its physical location using a trusted device, may be saved. This save may occur within the third additional block generated at step 314.

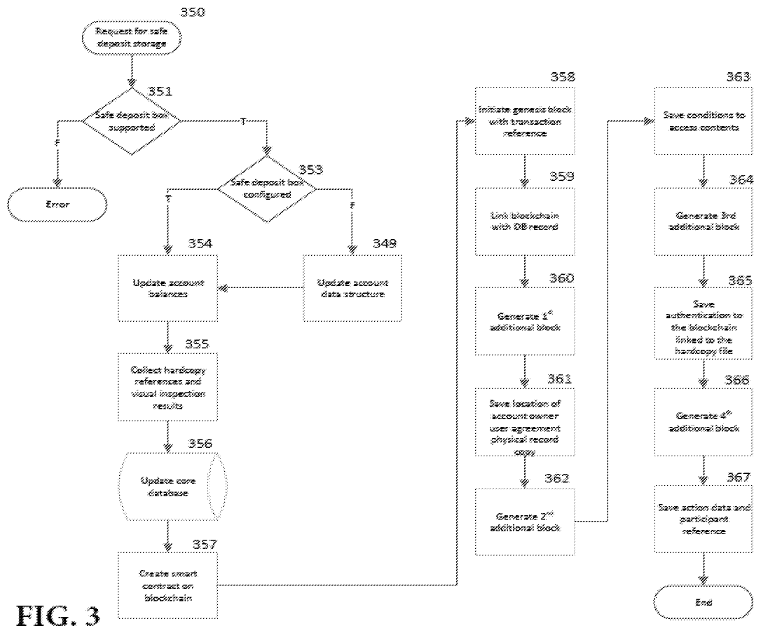

FIG. 3 is a flow and decision chart for a safe deposit storage request employing the creation of genesis block and further additional associated blocks according to an exemplary embodiment of the present invention.

According to this exemplary embodiment, at step 350, a user may make a request for safe deposit storage. The system may make a determination, at step 351, of whether the requested safe deposit box is supported, and report an error if it is not. If the safe deposit box is supported, at step 353, a determination may be made as to whether the safe deposit box has been configured. If not, at step 349, the account data structure may be updated. At step 354, account balances may be updated. At step 355, physical hardcopy reference documents may be collected, and may be visually inspected, for example, employing a device associated with a trusted individual. At step 356, the core database may be updated, for example based on the safe deposit box, the hardcopy references, and the visual inspection results. At step 355 hardcopy references, for example paper-based documents, may be collected and visually inspected, with the results being reported to the system. At step 356, the core database may be updated, for example with respect to the visual inspection results.

At step 357, a smart contact may be created on the blockchain, or on another IVATR. The smart contract may include a set of conditions to be met towards completion of a transfer or other transaction with verifiable results. In certain embodiments the smart contract may represent a digital asset—for example, ownership rights over personal property such as vehicle title, immovable property such as a builder's lien, easement or title, and accordingly the safe deposit box may serve as a safe deposit box for such digital assets. The transfer of such a digital asset between accounts may represent the transfer of ownership in the property. Advantageously, it is possible that the change of ownership becomes a fully binding deed or title transfer when recorded in, for example, a courthouse or assessor's office.

At step 358, a genesis block referencing the transaction may be initiated. Alternately, in place of a genesis block, an IVATR header or IVATR core, likewise referencing the transaction, may be used where an IVATR other than a blockchain is used. At step 359, the blockchain or IVATR, for example at the genesis block, IVATR header or IVATR core, may be linked with a database record, for example the portion of the database record updated at step 356.

At step 360, a first additional block associated with the blockchain or first additional IVATR storage portion associated with the other IVATR may be generated. At step 361, the location of the physical (such as paper) record copy of the account owner's user agreement, or of a different contractual document, may be saved. This location may be saved in the first additional block or first additional IVATR storage portion generated at step 360.

At step 362, a second additional block associated with the blockchain or second additional IVATR storage portion associated with the other IVATR may be generated. At step 363, conditions to access contents, for example to access contents of the core database or contents of the block or storage portion generated at step 360, may be saved. These conditions may be saved in the second additional block or second additional IVATR storage portion generated at step 362.

At step 364, a third additional block associated with the blockchain or third additional IVATR storage portion associated with the other IVATR may be generated. At step 365, information pertaining to the authentication of the hardcopy file may be saved. This authentication-related information may be saved in the third additional block or third additional IVATR storage portion generated at step 364.

At step 366, a fourth additional block associated with the blockchain or fourth additional IVATR storage portion associated with the other IVATR may be generated. At step 367, action data and/or reference to the relevant participants in the action may be saved. This action-related information may be saved in the fourth additional block or fourth additional IVATR storage portion generated at step 366.

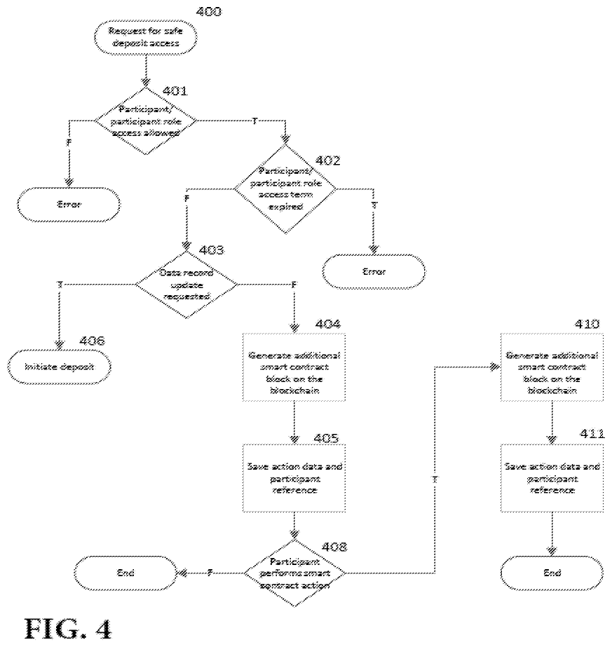

FIG. 4 is a flow and decision chart for a safe deposit access request involving the performance of smart contract-related functions according to an exemplary embodiment of the present invention.

At step 400, a user or participant may make a request for safe deposit access. At step 401, a determination may be made as to whether the user or participant, for example based on the user or participant's credentials or role, are sufficient for such access. If not, an error may be returned. Otherwise, a determination may be made at step 402 as to whether the access term for the participant has expired. If so, an error may be returned.

Otherwise, at step 402, a determination can be made as to whether a request has been made, for example by the user or participant, to update the data record associated with the deposit. If so, at step 406, the deposit can be initiated. If not, at step 404, a smart contract block may be generated on a blockchain, or a smart contract-data storing portion of an IVATR may be added to another IVATR. At step 405, action data and/or a reference to the user or participant may be saved, for example by being appended as an additional block on the blockchain or additional data storage portion on the IVATR.

At step 408, a determination can be made as to whether the user or participant is performing a smart contract action. If not, the process may end. If so, at step 410, an additional smart contract block may be generated on the blockchain, or an additional smart contract-data storing portion of an IVATR may be added to the other IVATR. At step 411, action data and/or a reference to the user or participant may be saved, for example by being appended as an additional block on the blockchain or additional data storage portion on the IVATR.

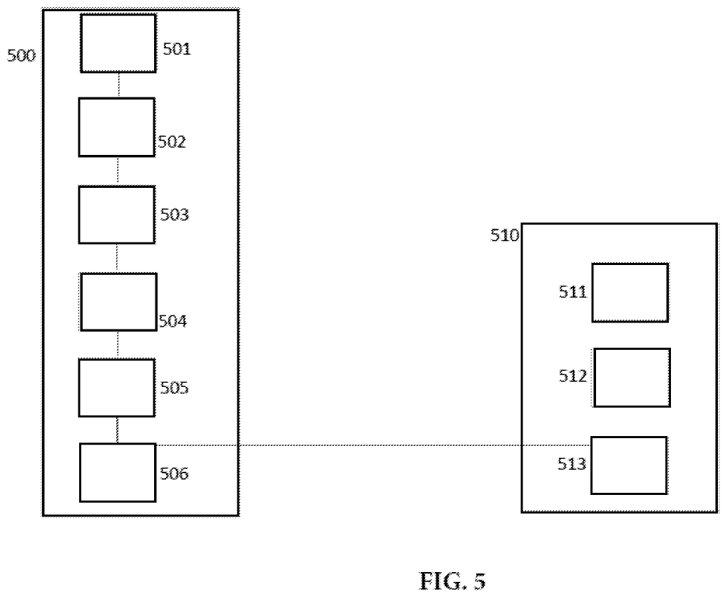

FIG. 5 is an exemplary embodiment of a data structure diagram showing an IVATR 500 with a genesis storage portion 501 and additional linked storage portions 502; 503; 504; 505; 506, and artifacts 511; 512; 513 in separate storage 510, which data structure may be used according to various systems and methods of the present invention.

The IVATR 500 may be a blockchain, with the genesis storage portion 501 being a genesis block and linked storage portions 502; 503; 504; 505; 506 being blocks appended to or associated with, directly, or indirectly, the genesis block. Alternately, the IVATR 500 may be an IVATR other than a block chain, with the genesis storage portion 501 being an IVATR core or IVATR header and linked storage portions 502; 503; 504; 505; 506 being storage portions appended to or associated with, directly or indirectly, the IVATR core or IVATR header.

The separate storage 510 may be off-blockchain or off-IVATR storage, with there existing the capability of linkages or associations between particular blocks or storage portions 501; 502; 503; 504; 505; 506 and artifacts 501; 502; 503. In this way, access to particular blocks or storage portions 501; 502; 503; 504; 505; 506 may be used to control access to (including, for example, read and/or write access) to particular artifacts 511; 512; 513. An example link is shown between storage portion 506 and artifact 513, but it will be understood that, in certain embodiments of the invention, such links may be made between any storage portion and any artifact. Such access control may employ, by way of example, using a public/private key infrastructure (PKI), or other methods of encryption or access control as may be known in the art.

It will be understood that the data structures such as are shown in FIG. 5 may be stored, for example, within the system architecture of FIG. 1 or alternately on other system architectures, in carrying out the systems and methods of the present invention.

In certain embodiments, computer-implemented methods of core banking service may be carried out. Such methods may manage complex data structures as bank records, and may involve receiving, using a computer processor, requests to deposit assets. The bank account records may include digital representations of obligations established by a user or participant based upon a transfer of an asset. The digital representations may include a set of conditions to be met towards the completion of the transfer, and which conditions and/or transfer may be verifiable. The digital representations may for example be in the form of a smart contract, or may be in the form of digitally signed database records, document scans or security event logs. The user or participant may, for example, be a property owner, a borrower, or an investor.

According to some embodiments, the computer processor may extract requested records. This may be done by extraction the records from a relational database format, which may be one of multiple such formats. The use of relational database formats is advantageous in that it is compatible with a significant portion of modern banking software, and permits convenient and reliable storage and querying of data. In certain embodiments, IVATR records can themselves be stored in a relational database. The extracted records may be converted into a genesis block 501 of a blockchain 500, or a IVATR core or IVATR header 501 where a different IVATR 500 than a blockchain is employed. The extracted records may further be parsed. The parsed records may be stored as one or multiple additional blocks 502; 503; 504; 505; 506, at least some of which may stored on the blockchain and linked or associated, directly or indirectly, with the genesis block 501, or as one or multiple additional data storage IVATR portions 502; 503; 504; 505; 506, at least some of which may be linked or associated, directly, or indirectly, with the IVATR core or IVATR header 501. At least one of these associated blocks or storage portions may memorialize an obligation via an agreement. In this manner, by storing both the parsed records and the extracted records on which they are based, a form of redundant storage may advantageously be achieved.

The blockchain or other IVATR may have associated ledger entries. Some or all of the ledger entries may be associated with a private key, for example where PKI is the chosen access control method. The private key(s) may be used to control access to portions of the blockchain. At least some of the block(s) or other storage portion(s) may be linked to hardcopy file, such as a paper or other document stored at a physical location. The physical location of the hardcopy file, which may, for example, be or incorporate the location of a building in which the hardcopy file is stored, linked to the block(s) or storage portion(s) may be recorded in the blockchain or other IVATR 500. This recording may be accomplished by storing such physical location information in a generated first additional block or storage portion 502 on the blockchain or IVATR 500, and the information may be stored as or in the form of action data (by way of example, data supporting or applicable to the event or action, such as scanned documents, recordings, or references to other IVATRs). The linkage of block(s) or other storage portion(s) to the hardcopy file may be accomplished for example by generating unique identifiers for each and storing both in one database record.

A record action may be linked to the action data. Such record action may be, for example, a deposit to the account, a communication event such as between the user or participant or customer and a bank operator, an account audit, an action necessary to protect the value of the account, an additional service offered such as based on service agreements. The action data may include or further include at least one of a type of action, a time and date of an action or action request, a deadline for complying, data related to a communication session (for example a phone communication or interaction, video communication or interaction, live communication or interaction) such as the duration of the communication session, a reason for performing an action, a change to a pending obligation, a read permission for a data portion 501; 502; 503; 504; 505; 506, an action taken in response to a request documented at a data portion 502; 503; 504; 505; 506 other than the genesis portion 501. The action data may include or further include access control data, such a private key, which may be used as a mechanism to permit access, through granted access rights, to the storage portion 501; 502; 503; 504; 505; 506 of the IVATR 500.

A second additional storage portion 503 of the IVATR 500 may be generated and linked with one or more of the first additional storage portion 502 and the genesis portion 501. The account action and/or the action data may be recorded at this second additional block 503.

A third additional storage portion 504 of the IVATR 500 may be generated and linked or associated with one or more of the prior storage portions 501; 502; 503. A record of a transfer related to an obligation, for example, an obligation memorialized in an account agreement, may be recorded in this third additional storage portion 504.

A fourth additional storage portion 505 of the IVATR 500 may be generated and linked or associated with one or more of the prior storage portions 501; 502; 503; 504. Data related to an authentication of the hardcopy file may be recorded in this fourth additional storage portion 505. The authentication may for example include results of a visual inspection of the hardcopy file stored at the physical location, for example one performed by a trusted person using a device. This device may be, for example, a uniquely identified device, such as a mobile smart-phone or other mobile smart device. The device may also be, for example, a mobile or non-mobile terminal located at the physical location. In certain embodiments, the device is registered with the system, is associated with the person and is capable of identifying that person (for example with a PIN, fingerprint recognition, facial recognition, or retinal scanning), and thereby the source of the authentication can be presumed to be the trusted source. Preferably, the authentication allows for evidence of the authentication event to be digitally saved. The unique identification may permit the association of such device with a unique participant, who may be a trusted participant.

A fifth additional storage portion 506 of the IVATR 500 may be generated and linked or associated with one or more of the prior storage portions 501; 502; 503; 504; 505. Beneficiary action data may be stored in this fifth additional storage portion 506. The beneficiary action data may be first converted, prior to storage, into a beneficiary institution format by a computer processor. Alternately, for example in situations where the beneficiary institution's format and/or protocol is not known or where conversion functionality is not available, a raw data stream may be stored in the fifth additional storage portion 506.

Access rights may be granted to the participant pertaining to one or more or all of the first additional storage portion 502, second additional storage portion 503, third additional storage portion 504, fourth additional storage portion 505, and/or fifth additional storage portion 506. Portions of the IVATR 500 associated with the granted access rights may be transmitted to the participant, for example by a secure file transfer protocol, email, delivery of a USB drive or other electronic recording medium, or such other electronic transfer methods as may be known in the art.

In a further embodiment of the present invention, electronic artifacts 511; 512; 513 such as may be stored in separate storage 510, (which may be off-IVATR 500 and/or off-blockchain 500 storage) which may be linked or associated with the storage portions for which the participant has access rights, may also be transmitted to the participant. The electronic artifacts may be in the form of, for example, scanned documents, email copies, screenshots, voice recordings, or other electronic files. The electronic artifacts may be stored in their original or native form or within a blockchain or other IVATR. Such transmittal may occur upon the participant's use of the storage portion-associated access control mechanism, for example the associated private key (where PKI is used).

In yet a further embodiment of the present invention, electronic artifact(s) associated with a post-IVATR or post-blockchain core banking processing event may be generated. This electronic artifact may be related to an agreement, for example a service agreement associated with a portion of the IVATR or blockchain, such as the portion for which content is transmitted to the participant. Accordingly, electronic artifact(s) may be stored in a database and linked to the blockchain or IVATR where they relate to events occurring in the banking core after all transaction-related data has been saved into the blockchain or IVATR. In certain embodiments, such an electronic artifact associated with a post-IVATR or post-blockchain core banking processing event may be stored in a sixth additional block or storage portion, which sixth additional block or storage portion may be suitable for appending onto and/or associating with the previous blocks or storage portions. This sixth additional block or storage portion may memorialize the post-blockchain core banking processing event. A hash may be associated with the sixth additional block, and a hash pointer may be associated with the hash. The sixth additional block may be appended onto or associated with the blockchain or IVATR, and may further be associated with a new ledger entry. Details of the new ledger entry may be transmitted to the user, consumer, or participant.

In certain embodiments, a consensus mechanism may be executed on a computer processor or local or distributed network, which consensus mechanism may reconcile the ledger entries.

In certain embodiments, post-blockchain electronic artifact(s) may also be placed in the off-blockchain storage or off-IVATR storage 510. In further embodiments, a log may be generated recording access, for example by the participant, user or consumer, to the off-blockchain storage or off-IVATR storage 510.

In certain embodiments, the methods discussed herein may be implemented by an apparatus for ingesting transaction record data into a blockchain or into another IVATR. The apparatus may include an ingestion controller, which may itself include a processor and a digital storage, which digital storage may contain code executable upon demand by the processor to cause the apparatus to perform the methods discussed herein.

Advantageously, the apparatuses, systems and methods discussed herein may permit the financial institution to handle the relationship between the basic financial industry roles, such as the customer, the bank and the assets custodian. Further advantageously, the assets custodian may engage in independent verification, transforming relationships expressed with smart contracts into independently verifiable asset values. Transparency may be increased, allowing all parties to clearly understand the underlying financial nature of the transactions, such as assets-to-liabilities ratios, tax implications from asset transfers, and overdraft protection.

In one embodiment of the present invention, there is a computer-implemented method of providing a core banking service managing complex data structures as bank account records in the form of digital representations of obligations established by a participant based upon a transfer of an asset, involving receiving, into a computer processor, a request to deposit an asset; extracting, using the computer processor, a bank account record in the form of a digital representation of an obligation based upon the transfer of the asset that is the subject of the deposit request; converting, using the computer processor, the extracted record into a genesis portion of an IVATR; parsing, using the computer processor, the extracted record into at least one storage portion; linking or associating, using the computer processor, at least one of the at least one storage portion with the genesis portion of the IVATR and storing the at least one of the at least one storage portion as part of the IVATR, where the at least one of the at least one storage portion memorializes an obligation via an agreement; generating, using the computer processor, a first additional storage portion linked or associated with, and stored as part of, the IVATR, where the first additional storage portion records a physical location of a hardcopy file as action data; linking or associating, using the computer processor, a record action with the action data; generating, using the computer processor, a second additional storage portion linked or associated with, and stored as part of, the IVATR, where the second additional storage portion records the record action; generating, using the computer processor, a third additional storage portion linked or associated with, and stored as part of, the IVATR, where the third additional storage portion records a transfer related to the obligation memorialized via the agreement; generating, using the computer processor, a fourth additional storage portion linked or associated with, and stored as part of, the IVATR, where the fourth additional storage portion memorializes an authentication of the physical location of the hardcopy file; generating, using the computer processor, a fifth additional storage portion linked or associated with, and stored as part of, the IVATR, where the fifth additional storage portion contains beneficiary action data; granting, using the computer processor, access rights to the participant, pertaining to each of the first additional storage portion, the second additional storage portion, the third additional storage portion, the fourth additional portion, and the fifth additional portion; and transmitting to the participant, using the computer processor, a portion of the IVATR authorized by the access rights.

In a further embodiment, the IVATR is a blockchain, the genesis portion is a genesis block, the first additional storage portion is a first additional block, the second additional storage portion is a second additional block, the third additional storage portion is a third additional block, the fourth additional portion is a fourth additional block, and the fifth additional portion is a fifth additional block.

In an alternate embodiment, the IVATR is non-blockchain, and the genesis portion is an IVATR header or an IVATR core.

In certain embodiments, the method further involves associating a private key with at least one ledger entry on the blockchain associated with at least one of the first additional block, the second additional block, the third additional block, the fourth additional block, and the fifth additional block; and controlling access to the at least one associated block of the blockchain based on the private key.

In a further embodiment, the bank account record is extracted from a relational database format, the parsing of the extracted record into at least one storage portion involves parsing the extracted record into multiple blocks, and the linking or associating the at least one of the at least one storage portion with the genesis portion of the IVATR and storing the at least one of the at least one storage portion as part of the IVATR involves adding at least one of the multiple blocks onto the genesis block.

In a yet further embodiment, the action data recorded in the first additional storage portion further includes at least one of a type of action, a time and date of an action request, a deadline for complying with a request, data related to a communication session, a reason for performing an action, a change to a pending obligation, a read permission for a portion of the IVATR, and an action taken in response to a request documented at a portion of the IVATR other than the genesis portion.

In a further embodiment, the action data recorded in the first additional storage portion further includes a private key used to control access to at least one portion of the IVATR.

In another embodiment, the record action recorded in the second additional storage portion includes at least one of: a deposit to the bank account, a communication event between a customer a bank operator, an audit on the bank account, an action necessary to protect the value of the bank account, and an additional service offered based upon the agreement.

In certain embodiments, the authentication of the physical location of the hardcopy file involves a visual inspection of the hardcopy file stored at the physical location by a trusted person using a device. The device may be a uniquely identified smart device or terminal at the physical location, associated with the trusted person and capable of recognizing the trusted person. The evidence of the authentication may be digitally saved.

In some embodiments, the method further involves transmitting an electronic artifact associated with one of the storage portions and stored in off-IVATR storage based on the private key. The off-IVATR storage portion may be a non-IVATR database. One of the storage portions may be associated with the agreement, and additionally involve generating an additional electronic artifact that is associated with a post-IVATR core banking processing event and that is also associated with the agreement.

Some embodiments may further involve generating a sixth additional block suitable for appending on the blockchain, where the sixth additional block has contents memorializing a post blockchain core banking processing event. They may also further involve associating a hash with the sixth additional block, associating a hash pointer with the hash, appending the sixth additional block onto the blockchain, and creating an accompanying ledger entry. They may additionally further involve transmitting information in the new ledger entry to the participant, placing a post blockchain electronic artifact in off-blockchain storage, associating the post blockchain electronic artifact with the sixth additional block, and generating a log recording access by the participant to the off-blockchain storage. The methods may involve transmitting information in the new ledger entry to the participant, placing a post blockchain electronic artifact in off-blockchain storage, associating the post blockchain electronic artifact with the sixth additional block, executing on the computer processor a consensus mechanism, and reconciling ledger entries on the blockchain.

In some embodiments, the bank account record in the form of a digital representation of an obligation based upon the transfer of the asset that is the subject of the deposit request is a smart contract.

In an additional embodiment, there is an apparatus for ingesting transaction record data into an IVATR so as to facilitate providing a core banking service managing complex data structures as bank account records in the form of digital representations of obligations established by a participant based upon a transfer of an asset, the apparatus including: an ingestion controller including a processor and a digital storage having executable code stored thereon executable on demand by the processor to receive, into the processor, a request to deposit an asset, extract, using the processor, a bank account record in the form of a digital representation of an obligation based upon the transfer of the asset that is the subject of the deposit request, convert, using the processor, the extracted record into a genesis portion of an IVATR, parse, using the processor, the extracted record into at least one storage portion, link or associate, using the processor, at least one of the at least one storage portion with the genesis portion of the IVATR and store the at least one of the at least one storage portion as part of the IVATR, where the at least one of the at least one storage portion memorializes an obligation via an agreement, generate, using the processor, a first additional storage portion linked or associated with, and stored as part of, the IVATR, where the first additional storage portion records a physical location of a hardcopy file as action data, link or associate, using the processor, a record action with the action data, generate, using the processor, a second additional storage portion linked or associated with, and stored as part of, the IVATR, where the second additional storage portion records the record action, generate, using the processor, a third additional storage portion linked or associated with, and stored as part of, the IVATR, where the third additional storage portion records a transfer related to the obligation memorialized via the agreement, generate, using the processor, a fourth additional storage portion linked or associated with, and stored as part of, the IVATR, where the fourth additional storage portion memorializes an authentication of the physical location of the hardcopy file, generate, using the processor, a fifth additional storage portion linked or associated with, and stored as part of, the IVATR, where the fifth additional storage portion contains beneficiary action data, grant, using the processor, access rights to the participant, pertaining to each of the first additional storage portion, the second additional storage portion, the third additional storage portion, the fourth additional portion, and the fifth additional portion, and transmit to the participant, using the processor, a portion of the IVATR authorized by the access rights.

What is claimed is:

1. A computer-implemented method of providing a core banking service managing complex data structures as bank account records in the form of digital representations of obligations established by a participant based upon a transfer of an asset, comprising:
receiving, into a computer processor, a request to deposit an asset;
extracting, using the computer processor, a bank account record in the form of a digital representation of an obligation based upon the transfer of the asset that is the subject of the deposit request;
converting, using the computer processor, the extracted record into a genesis portion of an IVATR;
parsing, using the computer processor, the extracted record into at least one storage portion;
linking or associating, using the computer processor, at least one of the at least one storage portion with the genesis portion of the IVATR and storing the at least one of the at least one storage portion as part of the IVATR, wherein the at least one of the at least one storage portion memorializes an obligation via an agreement;
generating, using the computer processor, a first additional storage portion linked or associated with, and stored as part of, the IVATR, wherein the first additional storage portion records a physical location of a hardcopy file as action data;
linking or associating, using the computer processor, a record action with the action data;
generating, using the computer processor, a second additional storage portion linked or associated with, and stored as part of, the IVATR, wherein the second additional storage portion records the record action;
generating, using the computer processor, a third additional storage portion linked or associated with, and stored as part of, the IVATR, wherein the third additional storage portion records a transfer related to the obligation memorialized via the agreement;
generating, using the computer processor, a fourth additional storage portion linked or associated with, and stored as part of, the IVATR, wherein the fourth additional storage portion memorializes an authentication of the physical location of the hardcopy file;
generating, using the computer processor, a fifth additional storage portion linked or associated with, and stored as part of, the IVATR, wherein the fifth additional storage portion contains beneficiary action data;
granting, using the computer processor, access rights to the participant, pertaining to each of the first additional storage portion, the second additional storage portion, the third additional storage portion, the fourth additional portion, and the fifth additional portion; and
transmitting to the participant, using the computer processor, a portion of the IVATR authorized by the access rights.

2. The method of claim 1, wherein the IVATR is a blockchain, the genesis portion is a genesis block, the first additional storage portion is a first additional block, the second additional storage portion is a second additional block, the third additional storage portion is a third additional block, the fourth additional portion is a fourth additional block, and the fifth additional portion is a fifth additional block.

3. The method of claim 1, wherein the IVATR is non-blockchain, and the genesis portion is an IVATR header or an IVATR core.

4. The method of claim 2, further comprising:
associating a private key with at least one ledger entry on the blockchain associated with at least one of the first additional block, the second additional block, the third additional block, the fourth additional block, and the fifth additional block; and
controlling access to the at least one associated block of the blockchain based on the private key.

5. The method of claim 2, wherein the bank account record is extracted from a relational database format, wherein the parsing of the extracted record into at least one storage portion comprises parsing the extracted record into multiple blocks, and wherein the linking or associating the at least one of the at least one storage portion with the genesis portion of the IVATR and storing the at least one of the at least one storage portion as part of the IVATR comprises adding at least one of the multiple blocks onto the genesis block.

6. The method of claim 1, wherein the action data recorded in the first additional storage portion further comprises at least one of a type of action, a time and date of an action request, a deadline for complying with a request, data related to a communication session, a reason for performing an action, a change to a pending obligation, a read permission for a portion of the IVATR, and an action taken in response to a request documented at a portion of the IVATR other than the genesis portion.

7. The method of claim 6, wherein the action data recorded in the first additional storage portion further comprises a private key used to control access to at least one portion of the IVATR.

8. The method of claim 1, wherein the record action recorded in the second additional storage portion comprises at least one of: a deposit to the bank account, a communication event between a customer a bank operator, an audit on the bank account, an action necessary to protect the value of the bank account, and an additional service offered based upon the agreement.

9. The method of claim 1, wherein the authentication of the physical location of the hardcopy file comprises a visual inspection of the hardcopy file stored at the physical location by a trusted person using a device.

10. The method of claim 9, where the device is a uniquely identified smart device or terminal at the physical location, associated with the trusted person and capable of recognizing the trusted person.

11. The method of claim 10, wherein evidence of the authentication is digitally saved.

12. The method of claim 4, additionally comprising transmitting an electronic artifact associated with one of the storage portions and stored in off-IVATR storage based on the private key.

13. The method of claim 12, wherein the off-IVATR storage portion is a non-IVATR database.

14. The method of claim 12, wherein the one of the storage portions is associated with the agreement, and additionally comprising generating an additional electronic artifact that is associated with a post-IVATR core banking processing event and that is also associated with the agreement.

15. The method of claim 2, further comprising generating a sixth additional block suitable for appending on the blockchain, wherein the sixth additional block has contents memorializing a post blockchain core banking processing event.

16. The method of claim 15, further comprising associating a hash with the sixth additional block, associating a hash pointer with the hash, appending the sixth additional block onto the blockchain, and creating an accompanying ledger entry.

17. The method of claim 16, further comprising transmitting information in the new ledger entry to the participant, placing a post blockchain electronic artifact in off-blockchain storage, associating the post blockchain electronic artifact with the sixth additional block, and generating a log recording access by the participant to the off-blockchain storage.

18. The method of claim 16, further comprising transmitting information in the new ledger entry to the participant, placing a post blockchain electronic artifact in off-blockchain storage, associating the post blockchain electronic artifact with the sixth additional block, executing on the computer processor a consensus mechanism, and reconciling ledger entries on the blockchain.

19. The method of claim 1, wherein the bank account record in the form of a digital representation of an obligation based upon the transfer of the asset that is the subject of the deposit request is a smart contract.

20. An apparatus for ingesting transaction record data into an IVATR so as to facilitate providing a core banking service managing complex data structures as bank account records in the form of digital representations of obligations established by a participant based upon a transfer of an asset, the apparatus comprising:
an ingestion controller comprising a processor and a digital storage having executable code stored thereon executable on demand by the processor to receive, into the processor, a request to deposit an asset, extract, using the processor, a bank account record in the form of a digital representation of an obligation based upon the transfer of the asset that is the subject of the deposit request, convert, using the processor, the extracted record into a genesis portion of an IVATR, parse, using the processor, the extracted record into at least one storage portion, link or associate, using the processor, at least one of the at least one storage portion with the genesis portion of the IVATR and store the at least one of the at least one storage portion as part of the IVATR, wherein the at least one of the at least one storage portion memorializes an obligation via an agreement, generate, using the processor, a first additional storage portion linked or associated with, and stored as part of, the IVATR, wherein the first additional storage portion records a physical location of a hardcopy file as action data, link or associate, using the processor, a record action with the action data, generate, using the processor, a second additional storage portion linked or associated with, and stored as part of, the IVATR, wherein the second additional storage portion records the record action, generate, using the processor, a third additional storage portion linked or associated with, and stored as part of, the IVATR, wherein the third additional storage portion records a transfer related to the obligation memorialized via the agreement, generate, using the processor, a fourth additional storage portion linked or associated with, and stored as part of, the IVATR, wherein the fourth additional storage portion memorializes an authentication of the physical location of the hardcopy file, generate, using the processor, a fifth additional storage portion linked or associated with, and stored as part of, the IVATR, wherein the fifth additional storage portion contains beneficiary action data, grant, using the processor, access rights to the participant, pertaining to each of the first additional storage portion, the second additional storage portion, the third additional storage portion, the fourth additional portion, and the fifth additional portion, and transmit to the participant, using the processor, a portion of the IVATR authorized by the access rights.
